(19) United States
(12) Patent Application Publication
(10) Pub. No.: US 2003/0233483 A1
(43) Pub. Date: Dec. 18, 2003

(54) Executing software in a network environment

(75) Inventors: Daniel Joseph Melchione, Beaverton, OR (US); Ricky Y. Huang, Portland, OR (US); Martin Kostadinov Stoilov, Beaverton, OR (US); Charles Leslie Vigue, LaPine, OR (US)

Correspondence Address: KLARQUIST SPARKMAN, LLP, 121 SW SALMON STREET, SUITE 1600, PORTLAND, OR, 97204, US

(73) Assignee: Secure Resolutions, Inc.

(21) Appl. No.: 10/421,651

(22) Filed: Apr. 22, 2003

Related U.S. Application Data
(60) Provisional application No. 60/375,210, filed on Apr. 23, 2002.

(51) Int. Cl. G06F 15/163

(52) U.S. Cl. 709/310

(57) ABSTRACT

An executable is executed on a computer via a software component with customization data. The software component can be embedded in a document such as a web page. The software component may be, for example, an ActiveX control or a Java applet. The executable can be a remote deployment utility for installing software. To perform a remote deployment operation, such as an installation, uninstall, or update, on client computers on a network, instructions are sent from an administrator computer to plural client computers on the network. The plural client computers can be located in different domains. The remote deployment operation is then performed on the client computers. A remote deployment operation may be performed using a downloaded remote deployment utility.

### PRIORITY CLAIM

This application claims the benefit of U.S. Provisional Patent Application No. 60/375,210, filed Apr. 23, 2002, which is hereby incorporated herein by reference.

### CROSS-REFERENCE TO OTHER APPLICATIONS

The U.S. provisional patent applications No. 60/375,215, Melchione et al., entitled, “Software Distribution via Stages”; No. 60/375,216, Huang et al., entitled, “Software Administration in an Application Service Provider Scenario via Configuration Directives”; No. 60/375,176, Vigue et al., entitled, “Fault-tolerant Distributed Computing Applications”; No. 60/375,174, Melchione et al., entitled, “Providing Access To Software Over a Network via Keys”; and No. 60/375,154, Melchione et al., entitled, “Distributed Server Software Distribution,” all filed Apr. 23, 2002, are hereby incorporated herein by reference.

### TECHNICAL FIELD

This invention relates to methods and systems for installing and executing software on computers, and more particularly to installing and executing software on computers in a network environment.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Organizations with large numbers of computer users face significant hurdles in keeping their software up to date. The resources dedicated to installing and updating software on computers within a large organization can be immense. Efficiency in updating, installing, and running new software is important in any computing environment, and particularly in organizations with large numbers of computer users.

If software is not efficiently distributed, installed, and updated, software may undergo several important revisions during the time it takes for IT personnel in an organization to perform just one update on computers in the organization. Therefore, there is a need for improvements in the field of software installation and administration.

### SUMMARY

The Internet provides a number of technologies useful for software installation. For example, web browsers are capable of downloading and running components such as ActiveX controls and Java applets from web pages; however, such components may need to be customized to address a particular situation appropriate for downloading, installing, or running of the software.

Further, relying on individual users to install software at their machines is often undesirable because such an approach relies on the ability and motivation of the user to perform the acts necessary to complete the installation. Many users may forget to update their software in a timely manner. Also, users may decide not to perform the installation, or they may perform it incorrectly. In such a scenario, it is highly unlikely that the installations will be performed consistently throughout the organization. As a result, the performance, security, and reliability of the organization's information systems are placed in jeopardy.

Various technologies described herein can address these and other problems. For example, methods and systems for invoking an executable on a computer are described herein. The methods and systems can be used in network arrangements, including those involving the Internet. The executable can be used, for example, to install software via a remote deployment (e.g., push) arrangement, but it can alternatively be used to perform other desired tasks.

In one embodiment, a software component, an executable, and customization data are acquired. The executable is invoked with the customization data via the software component.

The software component can be embedded in a document such as a web page. In some embodiments, the software component is an ActiveX control. In other embodiments, the software component is a Java applet. The executable file can be any of a number of different programs, such as a remote deployment utility, which allows an administrator to perform software administration operations such as remote deployment and installs, uninstalls, and updates on client computers.

If the software component is embedded in a web page presented by a browser, the executable can execute outside the browser. For example, the executable can appear in a separate window from the browser or run in a different process.

In some embodiments, a remote deployment (e.g., having push functionality) is used to perform a remote deployment operation on a network is first downloaded (e.g., via an Internet connection) from a data center along with a software component such as an ActiveX control or a Java applet. The software component is used to execute the remote deployment utility on a computer, and the remote deployment utility is used to perform the remote deployment operation on client computers on the network.

Installation technology described herein can be used to install software across multiple domains. For example, if an administrator has insufficient credentials (e.g., is logged in as a user not having rights) to perform installations in a domain, an installation attempt may fail. Responsive to the failure, a usemame and password can be acquired from the administrator, and impersonation can be used to achieve the installation.

Additional features and advantages will be made apparent from the following detailed description of illustrated embodiments, which proceeds with reference to the accompanying drawings.

### BRIEF DESCRIPTION OF THE DRAWINGS

FIG. 1 is an illustration of an exemplary application service provider scenario.

FIG. 2 is an illustration of an exemplary arrangement by which software administration can be accomplished via an application service provider scenario.

FIG. 3 depicts an exemplary user interface by which software administration can be accomplished in an application service provider scenario.

FIG. 4 illustrates an exemplary business relationship accompanying an application service provider scenario, such as that shown in FIGS. 1 or 2.

FIG. 5 is an exemplary overview of invocation of an executable with customization data via a software component.

FIG. 6 is a flow chart showing an exemplary method for invoking an executable with customization data via a software component.

FIG. 7 is a block diagram showing an exemplary system for invoking an executable with customization data via a software component.

FIG. 8 is a block diagram showing an exemplary system for achieving communication between an embedded software component and an executable.

FIG. 9 is a flow chart showing an exemplary method of providing customization data to a host computer, downloading a software component and an executable, and executing the executable.

FIG. 10 is a flow chart showing an exemplary method of executing a downloaded executable on a computer.

FIG. 11 shows an exemplary cabinet file for downloading from a host computer.

FIG. 12 shows an exemplary network arrangement in which a remote deployment operation may be performed.

FIG. 13 shows an exemplary user interface for launching a remote deployment utility.

FIG. 14 is a flow chart showing an exemplary method for launching a remote deployment utility.

FIG. 15 shows an exemplary user interface for performing a remote deployment operation on a multi-domain network.

FIG. 16 is a flow chart showing an exemplary method of performing a remote deployment on client computers on a network.

FIG. 17 is a flow chart showing an exemplary method of performing a remote uninstall on client computers on a network.

FIG. 18 is a flow chart showing an exemplary method of performing a remote deployment and update on client computers on a network.

FIG. 19 is a flow chart showing an exemplary method for performing a remote deployment operation on a multi-domain network.

FIG. 20 is an exemplary arrangement involving anti-virus software.

### DETAILED DESCRIPTION

### Application Service Provider Overview

The embodiments described herein can be implemented in an application service provider scenario. In particular embodiments, software administration can be accomplished via an application service provider scenario.

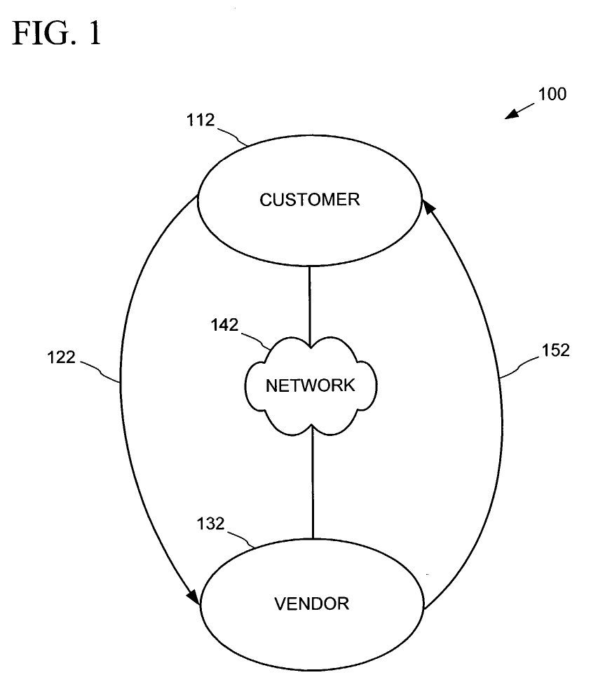

An exemplary application service provider scenario 100 is shown in FIG. 1. In the scenario 100, a customer 112 sends requests 122 for application services to an application service provider vendor 132 via a network 142. In response, the vendor 132 provides application services 152 via the network 142. The application services 152 can take many forms for accomplishing computing tasks related to a software application or other software.

To accomplish the arrangement shown, a variety of approaches can be implemented. For example, the application services can include delivery of graphical user interface elements (e.g., hyperlinks, graphical checkboxes, graphical pushbuttons, and graphical form fields) which can be manipulated by a pointing device such as a mouse. Other application services can take other forms, such as sending directives or other communications to devices of the vendor 132.

To accomplish delivery of the application services 152, a customer 112 can use client software such as a web browser to access a data center associated with the vendor 132 via a web protocol such as an HTTP-based protocol (e.g., HTTP or HTTPS). Requests for services can be accomplished by activating user interface elements (e.g., those acquired by an application service or otherwise) or automatically (e.g., periodically or as otherwise scheduled) by software. In such an arrangement, a variety of networks (e.g., the Internet) can be used to deliver the application services (e.g., web pages conforming to HTML or some extension thereof) 152 in response to the requests. One or more clients can be executed on one or more devices having access to the network 142. In some cases, the requests 122 and services 152 can take different forms, including communication to software other than a web browser.

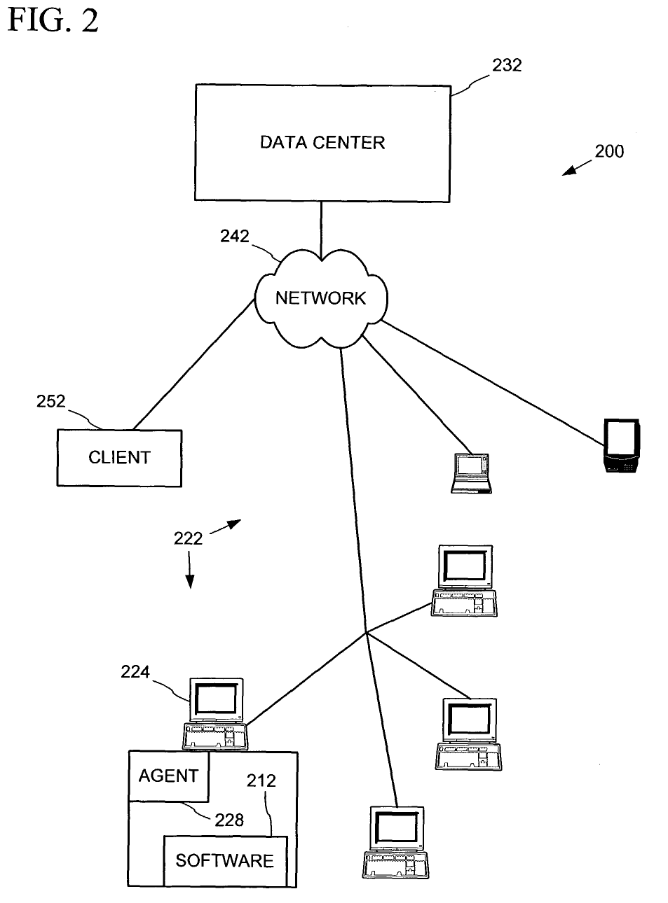

The technologies described herein can be used to administer software (e.g., one or more applications) across a set of administered devices via an application services provider scenario. Administration of software can include software installation, software configuration, software management, or some combination thereof. FIG. 2 shows an exemplary arrangement 200 whereby an application service provider provides services for administering software (e.g., administered software 212) across a set of administered devices 222. The administered devices 222 are sometimes called “nodes.”

In the arrangement 200, the application service provider provides services for administrating instances of the software 212 via a data center 232. The data center 232 can be an array of hardware at one location or distributed over a variety of locations remote to the customer. Such hardware can include routers, web servers, database servers, mass storage, and other technologies appropriate for providing application services via the network 242. Alternatively, the data center 232 can be located at a customer's site or sites. In some arrangements, the data center 232 can be operated by the customer itself (e.g., by an information technology department of an organization).

The customer can make use of one or more client machines 252 to access the data center 232 via an application service provider scenario. For example, the client machine 252 can execute a web browser, such as Microsoft Internet Explorer, which is marketed by Microsoft Corporation of Redmond, Washington. In some cases, the client machine 252 may also be an administered device 222.

The administered devices 222 can include any of a wide variety of hardware devices, including desktop computers, server computers, notebook computers, handheld devices, programmable peripherals, and mobile telecommunication devices (e.g., mobile telephones). For example, a computer 224 may be a desktop computer running an instance of the administered software 212.

The computer 224 may also include an agent 228 for communicating with the data center 232 to assist in administration of the administered software 212. In an application service provider scenario, the agent 228 can communicate via any number of protocols, including HTTP-based protocols.

The administered devices 222 can run a variety of operating systems, such as the Microsoft Windows family of operating systems marketed by Microsoft Corporation; the Mac OS family of operating systems marketed by Apple Computer Incorporated of Cupertino, Calif.; and others. Various versions of the operating systems can be scattered throughout the devices 222.

The administered software 212 can include one or more applications or other software having any of a variety of business, personal, or entertainment functionality. For example, one or more anti-virus, banking, tax return preparation, farming, travel, database, searching, multimedia, security (e.g., firewall) and educational applications can be administered. Although the example shows that an application can be managed over many nodes, the application can appear on one or more nodes.

In the example, the administered software 212 includes functionality that resides locally to the computer 224. For example, various software components, files, and other items can be acquired by any of a number of methods and reside in a computer-readable medium (e.g., memory, disk, or other computer-readable medium) local to the computer 224. The administered software 212 can include instructions executable by a computer and other supporting information. Various versions of the administered software 212 can appear on the different devices 222, and some of the devices 222 may be configured to not include the software 212.

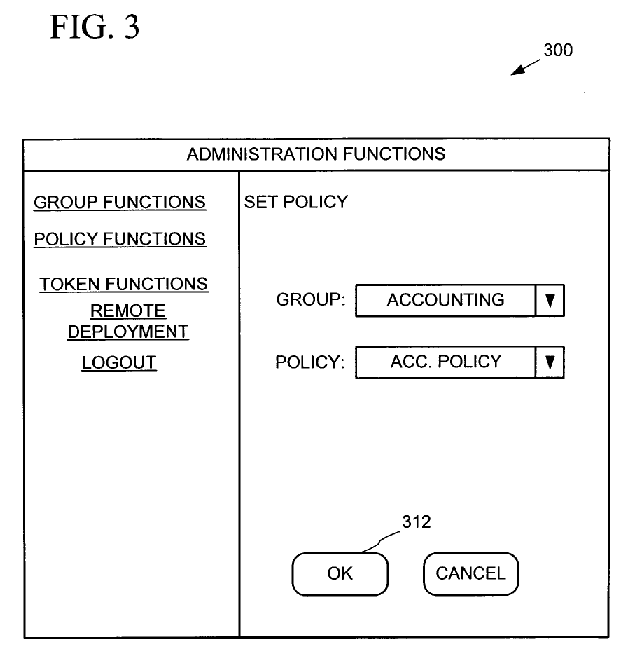

FIG. 3 shows an exemplary user interface 300 presented at the client machine 252 by which an administrator can administer software for the devices 222 via an application service provider scenario. In the example, one or more directives can be bundled into a set of directives called a “policy.” In the example, an administrator is presented with an interface by which a policy can be applied to a group of devices (e.g., a selected subset of the devices 222). In this way, the administrator can control various administration functions (e.g., installation, configuration, and management of the administered software 212) for the devices 222. In the example, the illustrated user interface 300 is presented in a web browser via an Internet connection to a data center (e.g., as shown in FIG. 2) via an HTTP-based protocol.

Activation of a graphical user interface element (e.g., element 312) can cause a request for application services to be sent. For example, application of a policy to a group of devices may result in automated installation, configuration, or management of indicated software for the devices in the group.

In the examples, the data center 232 can be operated by an entity other than the application service provider vendor. For example, the customer may deal directly with the vendor to handle setup and billing for the application services. However, the data center 232 can be managed by another party, such as an entity with technical expertise in application service provider technology.

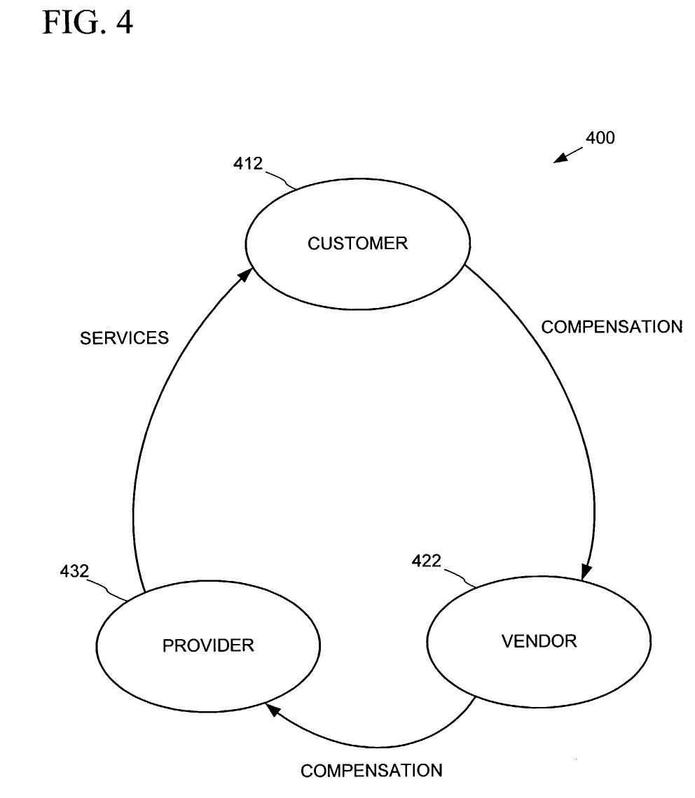

The scenario 100 (FIG. 1) can be accompanied by a business relationship between the customer 112 and the vendor 132. An exemplary relationship 400 between the various entities is shown in FIG. 4. In the example, a customer 412 provides compensation to an application services provider vendor 422. Compensation can take many forms (e.g., a monthly subscription, compensation based on utilized bandwidth, compensation based on number of uses, or some other arrangement (e.g., via contract)). The provider of application services 432 manages the technical details related to providing application services to the customer 412 and is said to “host” the application services. In return, the provider 432 is compensated by the vendor 422.

The relationship 400 can grow out of a variety of situations. For example, it may be that the vendor 422 has a relationship with or is itself a software development entity with a collection of application software desired by the customer 412. The provider 432 can have a relationship with an entity (or itself be an entity) with technical expertise for incorporating the application software into an infrastructure by which the application software can be administered via an application services provider scenario such as that shown in FIG. 2.

Although not shown, other parties may participate in the relationship 400. For example, network connectivity may be provided by another party such as an Internet service provider. In some cases, the vendor 422 and the provider 432 may be the same entity. It is also possible that the customer 412 and the provider 432 be the same entity (e.g., the provider 432 may be the information technology department of a corporate customer 412).

### EXAMPLE 1

### Exemplary Overview of Invocation of Executable with Customization Data via Software Component

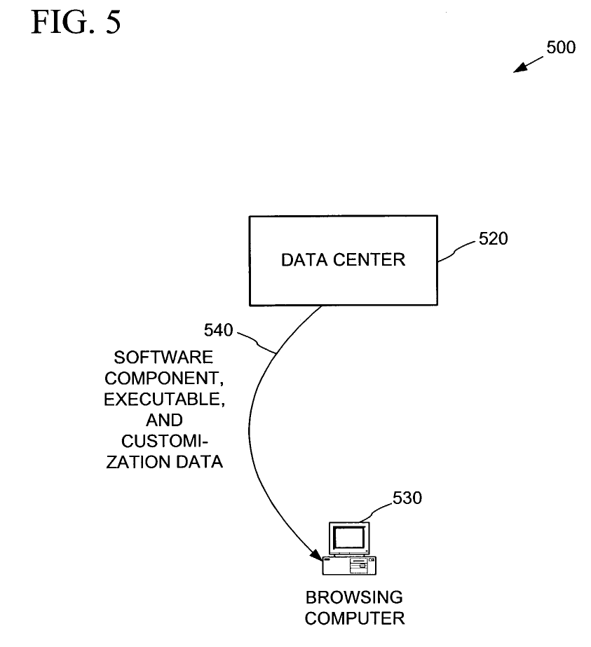

FIG. 5 provides an exemplary overview of invocation of an executable with customization data via a software component. In the example, a browsing computer 530 acquires a software component, an executable, and customization data from a data center 520 (e.g., one or more host computers) via a network connection 540.

References to the software component, executable, customization data, or some combination thereof can be acquired instead of acquiring the actual items. Accordingly, the software component, the executable, the customization data, or some combination thereof may reside at a location other than the data center 520 (e.g., at a mirror site or some other site for providing the items). The data center 520 can be maintained according to an application service provider scenario, and the items provided as application services.

The network connection 540 can be an Internet connection, and the items can be acquired through a firewall. For example, an HTTP-based protocol can be used to send the software component, the executable, the customization data, or some combination thereof.

In web-based scenarios, the software component may be embedded in a web page presented by a browser. In such an arrangement, the executable can be run outside the browser (e.g., in a separate window from the browser, in a different process, or both).

Although the language of this and various other examples is sometimes couched in terms of events happening at a client computer, it can sometimes be assumed that reciprocal events at one or more server computers (e.g., at a data center) can be carried out to achieve similar results (e.g., providing an executable rather than acquiring an executable).

### EXAMPLE 2

### Exemplary Method for Invocation of Executable with Customization Data via Software Component

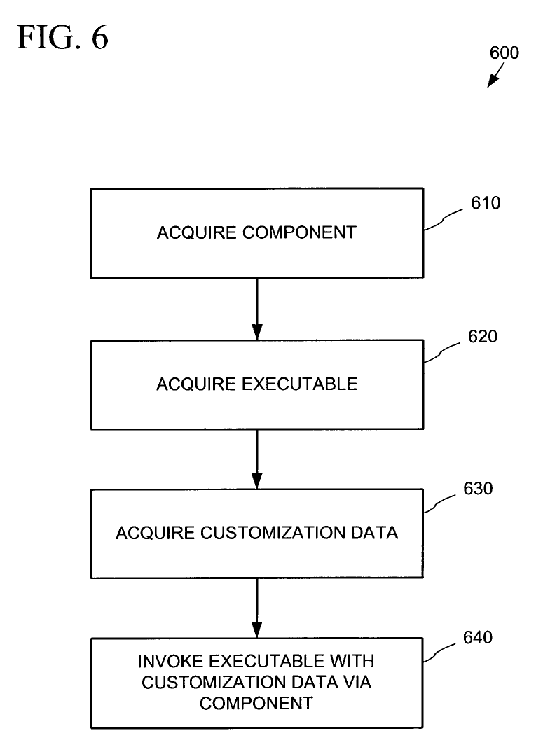

FIG. 6 shows an exemplary method 600 for invoking an executable with customization data via a software component. The method can be used in a system by which a software component is provided over a network connection (e.g., such as that shown in FIGS. 2 or 5)

At 610, a software component is acquired (e.g., via a network connection such as the Internet). At 620, an executable is acquired (e.g., via a network connection such as the Internet), and at 630, customization data is acquired (e.g., via a network connection such as the Internet). Then, at 640, the executable is invoked with the customization data via the software component.

The software component can take many forms, including those conforming to the ActiveX specification of Microsoft Corporation or the Java Applet specification of Sun Microsystems, Incorporated. The software component can be embedded in a document such as a web page (e.g., for delivery via an HTTP-based protocol).

The executable in any of the examples can take many forms (e.g., an .EXE file), and may be packaged for delivery via a network connection (e.g., in a .CAB, .ZIP, or .SEA file). If desired, the software component, the executable, the customization data, or some combination thereof, can be packaged in a single distribution unit (e.g., in a .CAB, ZIP, or .SEA file).

The depicted arrangement 600 is sometimes useful in environments where an executable cannot be executed directly (e.g., an .EXE file that cannot be directly executed by a web browser).

### EXAMPLE 3

### Exemplary System for Invocation of executable with Customization Data via Software Component

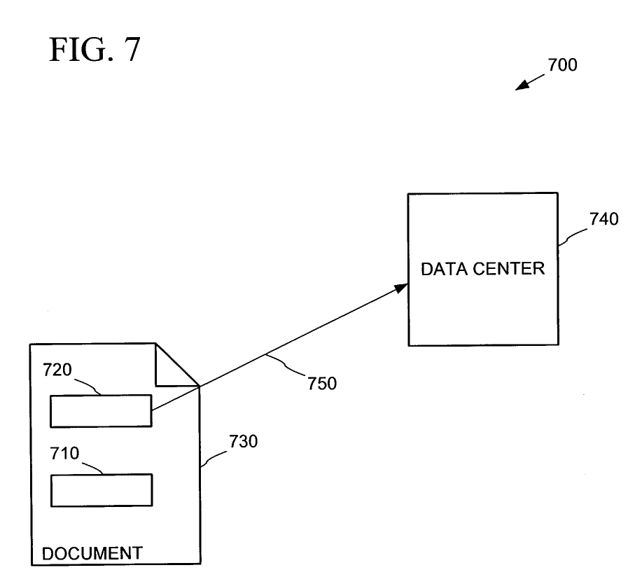

FIG. 7 shows a system 700 by which an executable can be invoked with customization data via a software component. In the example, customization data 710 and a reference to an embedded software component 720 reside in a document 730, which is provided by the data center 740. For example, the document 730 can be a web page provided by a web server at the data center 740 over a network connection 750 (e.g., the Internet). The document 730 can be provided to a client computer behind a firewall (e.g., via an HTTP-based protocol).

When processing the document 730 (e.g., with a browser at a client computer), the reference to the embedded software component 720 is encountered. The component can then be acquired (e.g., from the data center 740 or some other location). Or, alternatively, a check can be made to see if the component already resides on the client computer (i.e., acquisition need not take place). During acquisition of the software component, an executable can also be acquired and then invoked with reference to the customization data 710.

### EXAMPLE 4

### Exemplary System for Achieving Communication between an Embedded Software Component and an Executable

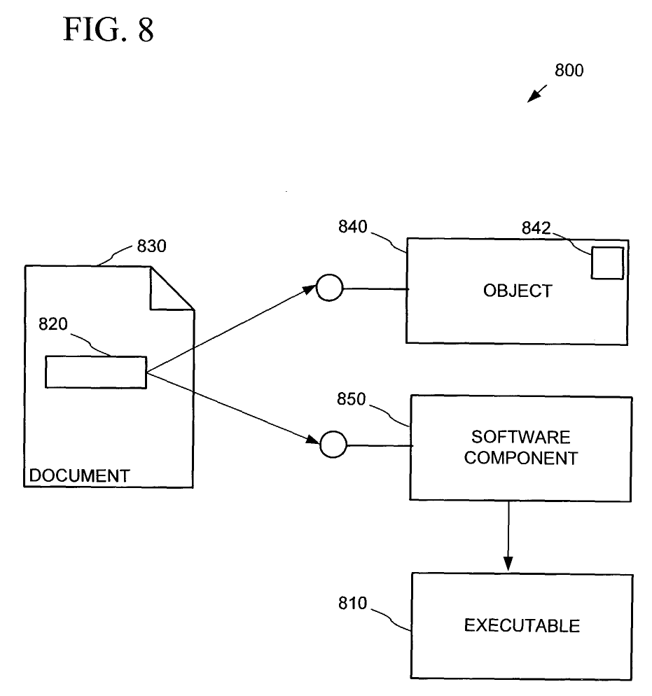

FIG. 8 shows an exemplary system 800 by which communication of customization data to an executable 810 can be achieved via a script 820 in a document 830. In the example, the script 820 can create an object 840 for holding the customization data 842 and place the customization data therein.

The script 820 can invoke the software component 850, which in turn invokes the executable 810. The software component 850 can access the object 840 for holding the customization data 842 and pass the customization data 842 (e.g., as parameters) to the executable 810. The object 840 can be a generic object that lacks particular functionality but is simply used as a store for the customization data 842. Accordingly, a different format or content can be used for the customization data 842 without having to specify a different class for the object 840.

The various items depicted (e.g., the object 840, the software component 850, and the executable 820) or some combination thereof can be bundled into a distribution unit (e.g., a .CAB, .ZIP, or .SEA file) and downloaded upon encountering a reference in the document 830.

For example, the Internet Component Download facility supported in Microsoft Internet Explorer will download a distribution unit upon encountering an appropriate <OBJECT> tag (e.g., with a CLSID specifying a component not already residing at the computer). In such a scenario, the source of the distribution unit can be specified via a CODEBASE parameter.

If desired, any of the distribution units described in any of the examples can be digitally signed. Authentication of the source of the distribution unit and verification that it has not been surreptitiously altered can be provided by a third party.

### EXAMPLE 5

### Exemplary Acquisition of Customization Data via a Form

The customization data depicted in the examples herein can be acquired in a number of ways. For example, a user can visit a web page containing an appropriate web-based form, fill in the form, and activate a user interface element that results in a document (e.g., the document 730 or the document 830) having appropriate customization data embedded therein. The executable can then be executed with the customization data (e.g., without further user intervention).

### EXAMPLE 6

### Exemplary Customization Data for Installing Software

The customization data can be any of a wide variety of data desired for use in execution with an executable (e.g., the executable 810). For example, if the executable is an installer program, the data can be an identifier specifying software that is to be installed via the installer program. Such an identifier can be generated in response to a request to install the software.

In such an example, the software to be installed can be specified over a network via an application service provider scenario (e.g., via an HTML form as specified above). In response to submitting the form, a document having appropriate information specifying the software (e.g., an installation token) can be sent to the client computer from which the form was submitted (e.g., a client computer being operated by an administrator wishing to install the software).

### EXAMPLE 7

### Exemplary Executables Related to Software Administration Scenarios

The technologies described herein can be used in conjunction with software administration scenarios. For example, it may be desirable to have software installed at an administered device. Exemplary executables in such scenarios include a utility for installing software at other administered devices or an agent for performing administration tasks as directed by (e.g., to implement) a set of configuration directives in an application service provider scenario.

### EXAMPLE 8

### Exemplary Method for Invoking Executable with Customization Data Acquired via a Web Page

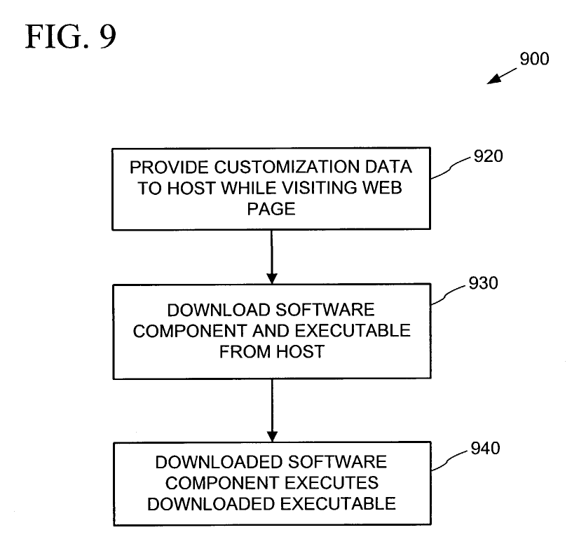

FIG. 9 shows a method 900 for invoking an executable with customization data acquired via a web page. In the example, customization data is provided to a host computer while visiting a web page (e.g., via an HTML form and collected via an HTTP-based protocol) at 920.

At 930, a software component and an executable are downloaded (e.g., from the host computer or a location specified thereby). At 940, the software component invokes the executable based on the customization data provided at 920. In some cases, the customization data can be passed unmodified to the executable. However, in some cases the customization data can be modified or augmented before passing to the executable.

### EXAMPLE 9

### Exemplary Implementation

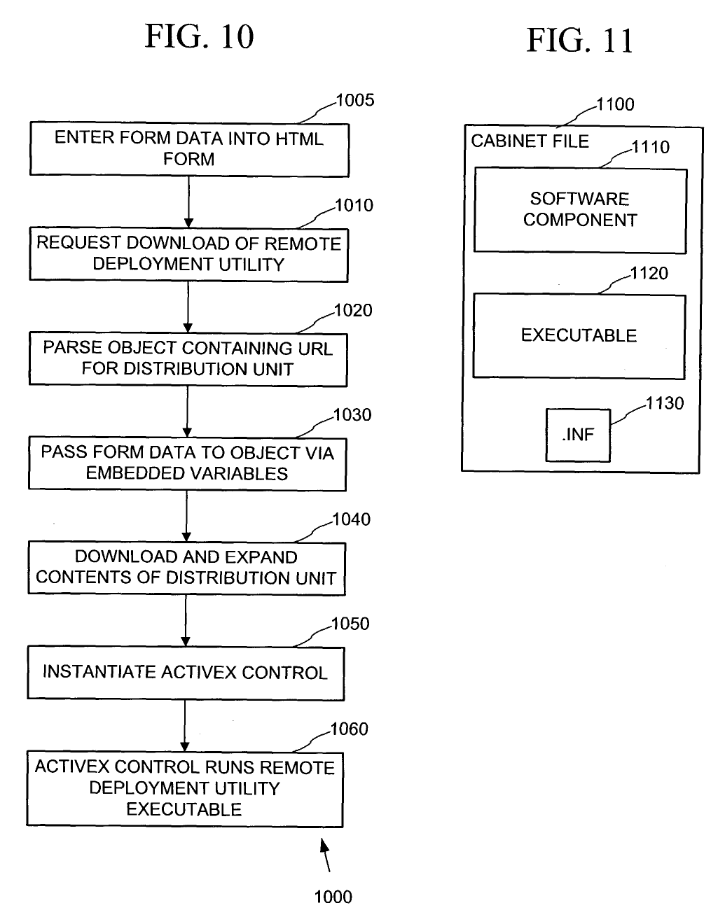

FIG. 10 shows an exemplary method 1000 for running a remote deployment utility via an ActiveX control. At 1005, customization data is entered into an HTML form on a web page being accessed via a web browser by a user on a computer (e.g., via an HTTP-based protocol). The exemplary embodiment involves web page elements written in HTML. However, other languages suitable for rendered documents could be used.

The exemplary customization data relates to the user and/or a computer, network, group of computers on a network, or organization with which the user is associated. However, the customization data need not be entered on the web page by the user, and an HTML form is not required for entering or collecting the customization data. For example, referring to FIG. 5, the customization data may be automatically provided to a host computer at a data center 520 when a user logs in to the data center 520.

Referring again to FIG. 10, a request is made to download software at 1010. In an illustrated embodiment, the request is made when visiting a web page. The user can initiate such a request by activating a user interface element on a first web page. A resulting second web page can contain an embedded software component that sends the request (e.g., to download software) to a host computer. In the example, the requested software is a remote deployment utility. An object, such as an HTML object, on the web page is parsed (1020) to obtain a URL for a distribution unit containing the desired software. In the example, the distribution unit is a file conforming to the cabinet (.CAB) specification of Microsoft Corporation.

Referring to FIG. 11, in an exemplary system, a cabinet file 1100 contains a software component 1110, an executable 1120 (such as an .EXE file), and an .INF file 1130. The illustrated arrangement can be used in conjunction with Microsoft's Internet Component Download system. The cabinet file contains an .INF file 1130, which contains instructions for processing software in the cabinet file (e.g., instructing execution of the software component 1110 upon download). If the software is packaged in more than one file, the .INF file 1130 may contain instructions for downloading the software packaged in the additional files, as well.

In addition to the .INF file 1130, the cabinet file 1100 in an illustrated embodiment contains a remote deployment utility executable for the executable 1120, an ActiveX control for the software component 1110, and software to be distributed to other computers using the remote deployment utility. However, other, alternative sets of software files may be included in the cabinet file. For example, the cabinet file 1100 may include a Java applet as an alternative to, or in addition to, an ActiveX control. Furthermore, the ActiveX control or Java applet may be downloaded separately from or without regard to a cabinet file 1100.

The type of executable 1120 included in the cabinet file 1100 is not limited to any particular kind of executable. Moreover, while an illustrated embodiment uses a cabinet file 1100 containing software to be distributed to other computers, such software is optional, and may be substituted with other software (whether or not for distribution to other computers) or omitted from the cabinet file 1100.

The text in Table 1 shows an excerpt of HTML in an illustrated embodiment that specifies a generic object named “objGeneric,” which can be used to hold customization information. The object in the excerpt contains a class identifier (CLASS ID) and a codebase attribute, which includes a URL for the cabinet file. The object can be used, for example, as the object 840 of FIG. 8.

The excerpt also specifies an embedded software component named “objInstInfo.” The embedded software component can be used, for example, as the component 850 of FIG. 8 and can accordingly invoke an executable. Other arrangements for the objects are possible.

TABLE 1
HTML for Generic Object and Embedded Software Component

<OBJECT CLASSID=
“clsid:D289E463-771A-4964-B664-F3020E751A56”

ID=objGeneric
codebase=“http://install.secureresolutions.com/vrasp/cabs/sres/0

409/020205A/SrDeploy.cab#Version=1, 0, 0, 0”>

</OBJECT>
<OBJECT CLASSID =
“clsid:3CD84BFA-2DCA-4AGB-A3CB-OB7E877B0E93”
ID=objInstInfo></OBJECT>

Customization data is then passed to the object at 1030. Customization data passed in this way is used in one embodiment to customize the functionality or content of the downloaded software. The text of Table 2 shows an example of how object variables are assigned values in an illustrated embodiment. For example, the values may be placed into the script via data acquired from an HTML form.

TABLE 2
Script for Passing Customization Data to a Generic Object

<script language=“javascript”>

objGeneric.organizationId = “{18F865D9-AC07-4AAF-AE89-

DF3533AD147C}”;

objGeneric.installToken = {F77lF6CF-F661-4BD4-938C-

08AD4383365A}”;

objGeneric.updatelUrl=http://install.secureresolutions.com/vrasp

/cabs/sres/0409”;

objGeneric.uploadAcceptor=“http://Upload.secureresolutions.com/

index.asp

objGeneric.oem=“Secure Resolutions”
objGeneric.nodeId=objInstInfo.GetNodeId ( )

The contents of the cabinet file are downloaded and expanded at 1040, and an ActiveX control is instantiated at 1050. After the cabinet file has been downloaded (e.g., and expanded), the executable is invoked by the ActiveX control. An .INF file associated with the cabinet file can specify that the ActiveX control in the cabinet file is to be invoked. The ActiveX control then invokes the executable at 1060.

Alternatively, a script can invoke the ActiveX control as shown in Table 3.

TABLE 3
Script for Invoking ActiveX Control that Invokes Executable

var xmlPath = “%Windows%\\SrDeploy\\NodeInfo.xml”;
var xmlRoot = “srNodeInfo”;
objInstInfo.BuildXMLFile( xmlPath, xmlRoot, objGeneric);
var deploy ProgramPath = “%Windows%\\SrDeploy\\DeployInst.exe”;
objInstInfo.Run(deployProgramPath, “”, false);
</script>

However, in other embodiments, the executable may be launched by some other component, such as a Java applet. In this way, an embedded software component such as an ActiveX control is used to run an executable that was downloaded with the ActiveX control, where the downloading was performed after customization data was transmitted to the source of the downloaded files.

The customization data can be used to customize or enhance the functionality of the executable. For example, in one embodiment, the customization data is used to assist a user in performing a remote deployment operation on computers on a network via a remote deployment utility executable.

### EXAMPLE 10

### Remote Deployment for Installing, Uninstalling and Updating Software

In another illustrated embodiment, a remote deployment utility (e.g., with push functionality) allows an administrator to perform a remote deployment operation for software on client computers in more than one domain. A remote deployment operation includes any modification of software stored on a different computer (e.g., a client computer) initiated by an administrator (e.g., delivering software, installing software, uninstalling software, or updating software). A remote deployment operation can operate without a request by the client computer.

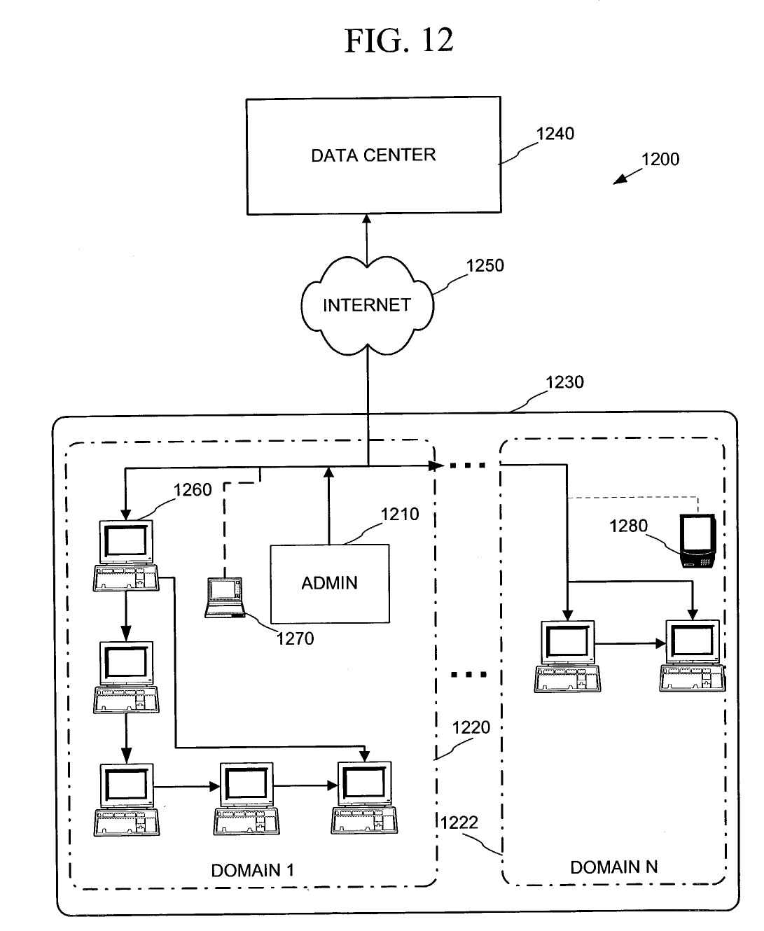

Referring to FIG. 12, an arrangement 1200 includes a computer 1210 accessed by an administrator on a computer in a domain 1220 on an organization's network 1230. A domain refers to a group of computers within a network boundary. For example, the boundary may be defined by a domain controller. Computers within the group may be administrated by an administrator with certain rights (e.g., a user name and password associated with administrative privileges) as established by credentials valid within the domain. The boundaries of a domain need not parallel physical network boundaries. Exemplary details pertaining to performing remote deployment operations on computers on multiple domains are provided below.

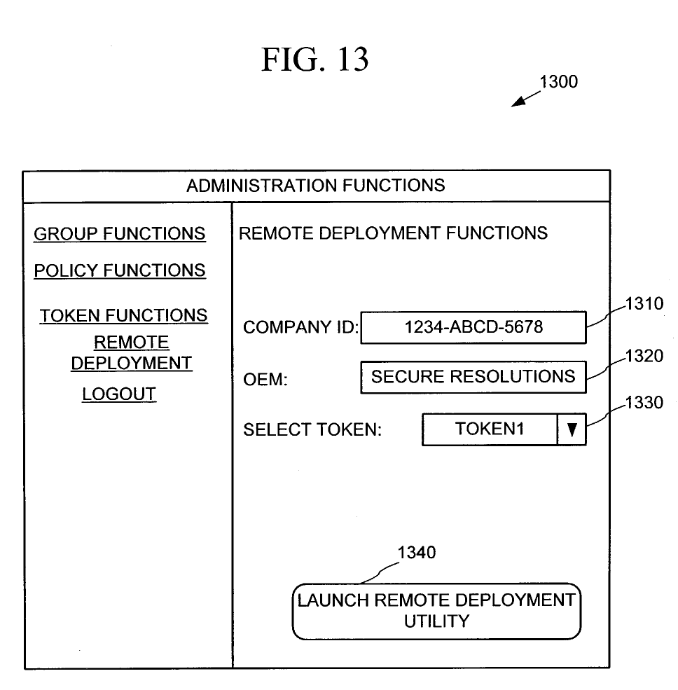

In an illustrated embodiment, data center 1240 is accessible via the Internet 1250 by the computer 1210 (e.g., via an application service provider scenario). An administrator wishing to perform a remote deployment operation on one or more client computers (such as a desktop computer 1260, a laptop computer 1270, or a personal digital assistant 1280) can access the data center 1240 with a web browser via an Internet connection. Using the web browser at the computer 1210, an administrator navigates to a web page for providing remote deployment functions that provides a user interface 1300 (FIG. 13) comprising HTML form elements to the administrator. Referring to FIG. 13, the company ID field 1310 contains a unique identifier associated with the organization of the administrator (e.g., who may be accessing the HTML form via the computer 1210). The administrator can be someone from outside the organization (e.g., a consultant) who is performing administration functions for the organization. The OEM field 1320 provides a name of an original equipment manufacturer (e.g., of the software being administered).

The token field 1330 allows the administrator to provide information (e.g., an install token) to the data center 1240 regarding which client computers in the organization will be the subject of a remote deployment (e.g., push) operation. In an illustrated embodiment, a token is associated with a group of client computers which share certain configuration characteristics; the token provides information including an organization identifier, a group identifier, a token name, a creation date, an expiration date, and an indicator showing whether the token is currently valid. However, the token may include additional information. For example, a token may include a limit on the number of software installations that can be initiated using the token.

In alternative embodiments, information provided to the data center 1240 need not include any of the information shown in fields 1310-1330, and may include additional information not provided in fields 1310- 1330 that may be entered via other HTML form elements, or provided to the data center by some other means. For example, information may be provided to the data center 1240 regarding a specific version of software that the administrator 1210 wishes to download, or information may be provided relating to a license agreement or purchase order pertaining to the software to be downloaded.

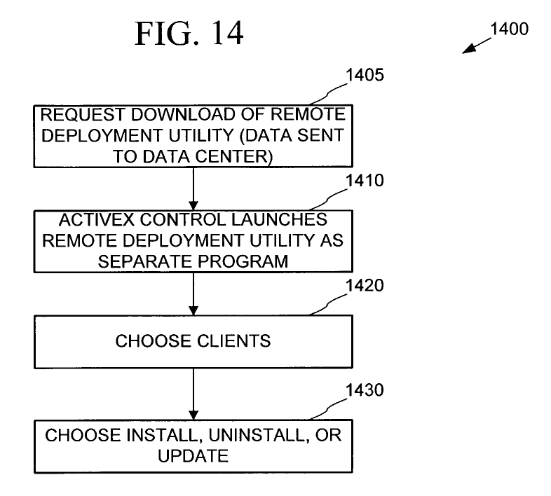

FIG. 14 shows a method 1400 for achieving a remote deployment (e.g., push) installation. When the desired installation information has been entered via a user interface (e.g., the user interface 1300 of FIG. 13), at 1405, the administrator requests activation of a remote deployment utility by activating a user interface element (e.g., the user interface element 1340). If not present on the computer, the remote deployment utility can be automatically downloaded thereto.

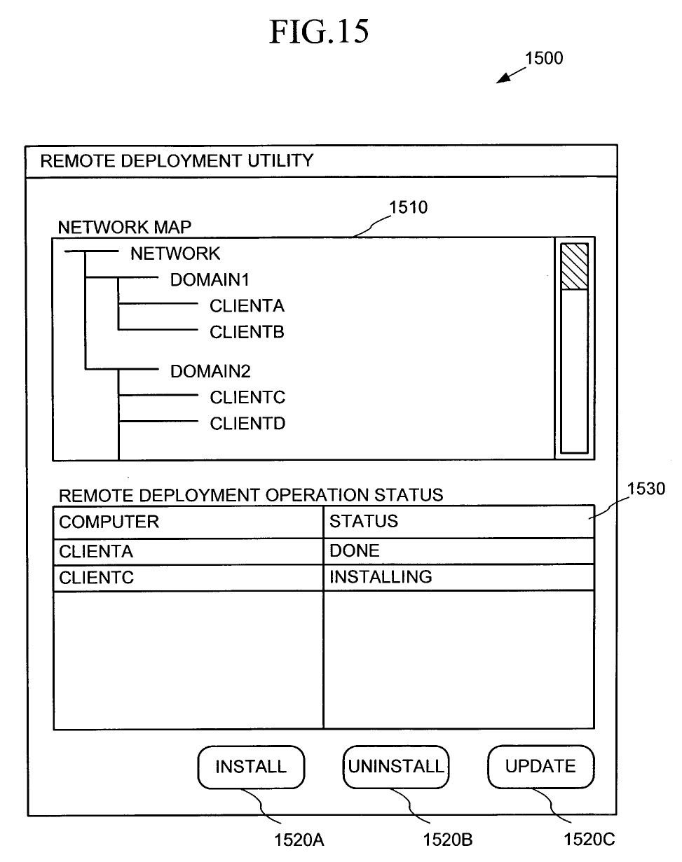

The information provided to the data center is used by the data center to determine what to provide to the computer operated by the administrator. An ActiveX control and a remote deployment utility executable can be downloaded, and the ActiveX control can launch the remote deployment utility at 1410, which runs independently from the web browser (e.g., in a different process). An exemplary user interface for the remote deployment utility is shown in FIG. 15. However, the remote deployment utility could be executed in a different way. In addition, software to be remotely deployed and installed via the remote deployment utility can be downloaded as well.

Because downloading ActiveX controls from unknown sources poses security risks, the ActiveX control can have an associated digital signature or certificate to verify the source of the control.

The ActiveX control provides information that was provided to the data center to the remote deployment utility. At 1420, the remote deployment utility allows the administrator to choose which client computers on which to perform a remote deployment operation, and, at 1430, to choose the type of remote deployment operation to perform. The remote deployment operations can then be performed.

FIG. 15 shows a user interface 1500 for a remote deployment utility in an illustrated embodiment. The administrator chooses client computers on which to perform the desired remote deployment operation in network map window 1510. There are various other methods of mapping a network and displaying a network map. In one embodiment, the administrator chooses client computers in more than one domain. In another embodiment, client computers also may be pre-selected based on information provided to the data center before the download of the remote deployment utility. The type of remote deployment operation to be performed is selected by activating user interface elements such as push-buttons 1520A-C. The status of the remote deployment operation for each selected computer is shown in a status window 1530. In an illustrated embodiment, the status window 1230 shows that a remote installation is being performed on CLIENTA and CLIENTC client computers as a result of the two computers (e.g., in different domains) being selected by an administrator. The status window 1530 includes columns for displaying names of client computers and the status of the remote deployment operation. However, other information could also be included in the status window, such as estimated time remaining or disk space remaining. Furthermore, the status column may display other status messages, such as “uninstalling,” “updating,” or an error message.

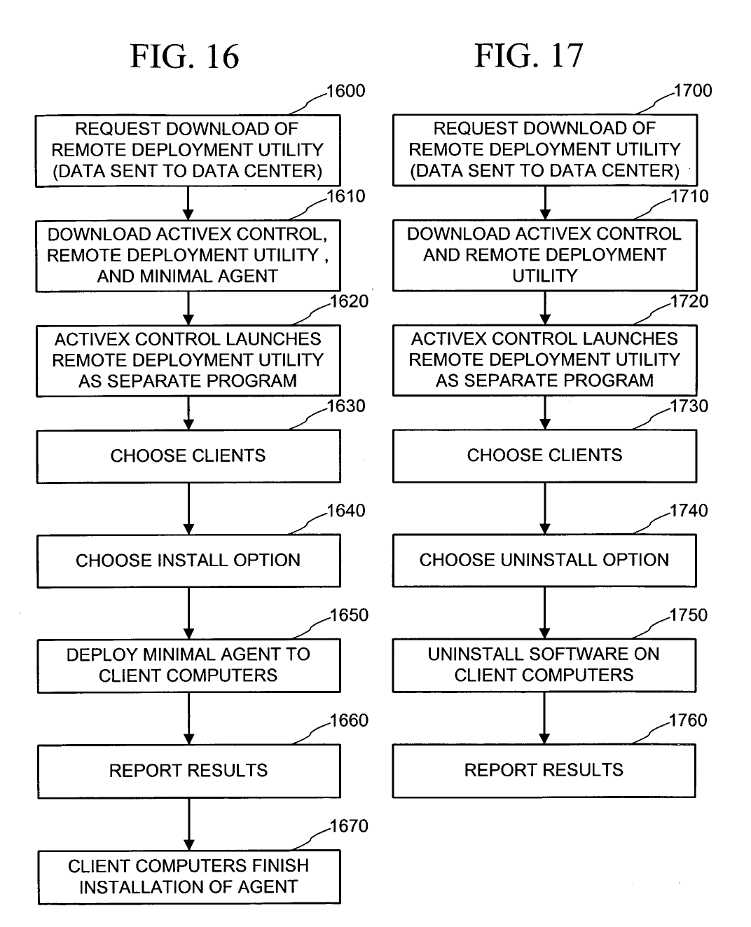

FIG. 16 illustrates an embodiment of a remote deployment operation to install minimal agent software, which enables client computers to communicate with and download files from a server (e.g., at a data center or within an organization). After a request to download the remote deployment utility (e.g., having push functionality) at 1600, the remote deployment utility is downloaded at 1610 along with an ActiveX control and minimal agent software. The ActiveX control launches the remote deployment utility at 1620, and client computers on which the remote deployment will be performed are chosen at 1630.

After the install option is chosen at 1640 in the remote deployment utility user interface, the minimal agent is installed by a remote deployment (e.g., push) operation to the selected client computers at 1650. Results of the installation process are reported for display to the status window at 1660. Installing the minimal agent on client computers enables the client computers to complete the installation of the full agent at 1670 by communicating with a server such as the data center 1240 (FIG. 12). However, remote deployment may also be used to perform a full installation of software to client computers, with no additional installation to be initiated by the client computers.

FIG. 17 illustrates an embodiment of a remote uninstall operation. After a request to download the remote deployment utility at 1700, the remote deployment utility is downloaded along with an ActiveX control at 1710. The ActiveX control launches the remote deployment utility at 1720, and client computers on which the remote uninstall will be performed are chosen at 1730. After the uninstall option is chosen in the remote deployment utility user interface at 1740, the desired software is uninstalled by a remote operation on the selected client computers at 1750. Results of the uninstall process are reported and displayed to the status window at 1760.

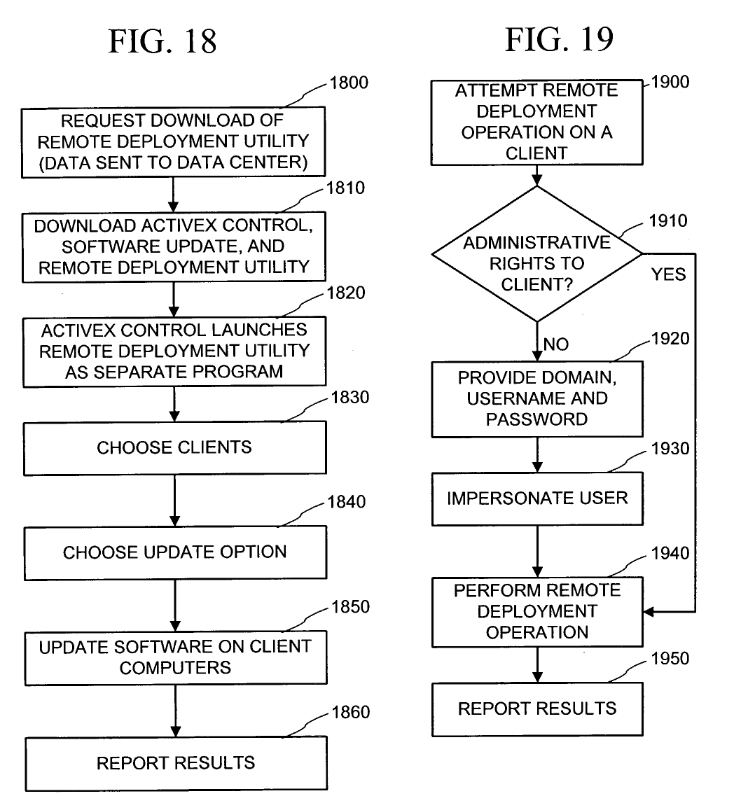

FIG. 18 illustrates an embodiment of a remote deployment and update operation. After a request to download the remote deployment utility at 1800, the remote deployment utility is downloaded along with an ActiveX control at 1810. The ActiveX control launches the remote deployment utility at 1820, and client computers on which the remote update will be performed are chosen at 1830. After the update option is chosen in the remote deployment utility user interface at 1840, software on the selected client computers is updated at 1850. Results are reported and displayed to the status window at 1860.

As explained above, a remote deployment operation can be performed on client computers residing in different domains, such as domains 1220 and 1222 in FIG. 12. In an illustrated embodiment, a remote deployment operation is performed on client computers on plural Microsoft Windows NT domains, including a client computer on a domain different than the domain on which the administrator is located. However, such an operation may also be performed on other operating systems, such as a Microsoft Windows 9× platform.

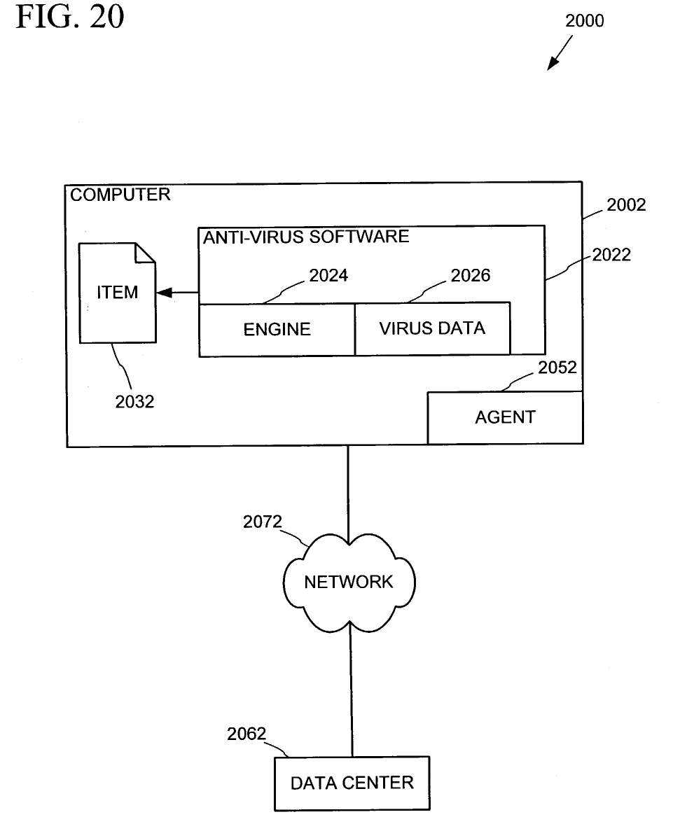

Referring to FIG. 19, a remote deployment (e.g., push) operation is attempted on the selected client computers at 1900. If the administrator initiating the remote deployment operation has administrative rights to a client at 1910, then the remote deployment operation is performed at 1940. However, if the attempt to perform a remote deployment operation on a client fails, the administrator is prompted to provide appropriate credentials (e.g., domain, username, and password information) for the client install at 1920. For example, referring to FIG. 15, if the attempt to perform a remote deployment operation on computer CLIENTC fails, then, responsive to the failure, the administrator is prompted to provide domain, username, and password information for CLIENTC (e.g., a name and password with administrative rights in domain2). Such an arrangement can be useful, for example, to allow an administrator to specify a plurality of computers without regard to the computers' domains. The software will automatically prompt for additional credentials, if appropriate, to finish the remote deployment operations to the specified computers.

Referring again to FIG. 19, providing this information allows the administrator to impersonate a user on the client computer on which the remote deployment operation is to be performed at 1930, thus providing the necessary rights to perform the remote deployment operation. The remote deployment operation is performed at 1940, and results are reported and displayed to a status window at 1950.

In an illustrated embodiment in a Windows NT environment, the administrator performs remote deployment and installation of a program on a client computer on a different domain by providing information for impersonating a user (and then impersonating the user) on the client computer using the functions LogonUser and ImpersonateLoggedOnUser shown in Table 4.

TABLE 4
Impersonating a User

BOOL LogonUser(

| | |
|---|---|
| LPTSTR lpszUsername, | // user name |
| LPTSTR lpszDomain, | // domain or server |
| LPTSTR lpszPassword, | // password |
| DWORD dwLogonType, | // type of logon operation |
| DWORD dwLogonProvider, | // logon provider |
| PHANDLE phToken | // receive tokens handle |

);
BOOL ImpersonateLoggedOnUser

| | |
|---|---|
| HANDLE hToken | // handle to token for logged-on user |

);

The program files are copied to the client computer using Admin$. The service control manager is opened on the client computer, and an installation service is installed. The installation service is opened and started. The installation service installs the program.

In one embodiment, the software installed is minimal agent software, which enables client computers to communicate with and download files from a server. In a Windows NT environment, using the service control manager application programming interface, the software can be activated with a remote procedure call, and no system reboot is required. However, in a Windows 9× environment, a reboot can be performed to achieve installation.

### EXAMPLE 11

### Anti-Virus Software Administration

In any of the examples described herein, the software being installed or otherwise administered can be anti-virus software or an agent for an anti-virus software system. An exemplary anti-virus software arrangement 2000 is shown in FIG. 20.

In the arrangement 2000, a computer 2002 (e.g., a node) is running the anti-virus software 2022. The anti-virus software 2022 may include a scanning engine 2024 and the virus data 2026. The scanning engine 2024 is operable to scan a variety of items (e.g., the item 2032) and makes use of the virus data 2026, which can contain virus signatures (e.g., data indicating a distinctive characteristic showing an item contains a virus). The virus data 2026 can be provided in the form of a file.

A variety of items can be checked for viruses (e.g., files on a file system, email attachments, files in web pages, scripts, etc.). Checking can be done upon access of an item or by periodic scans or on demand by a user or administrator (or both).

In the example, agent software 2052 communicates with a data center 2062 (e.g., operated by an application service provider) via a network 2072 (e.g., the Internet). Communication can be accomplished via an HTTP-based protocol. For example, the agent 2052 can send queries for updates to the virus data 2026 or other portions of the anti-virus software 2022 (e.g., the engine 2024).

### Alternatives

Having described and illustrated the principles of our invention with reference to illustrated embodiments, it will be recognized that the illustrated embodiments can be modified in arrangement and detail without departing from such principles. It should be understood that the programs, processes, or methods described herein need not be related or limited to any particular type of computer apparatus. Various types of general purpose or specialized computer apparatus may be used with or perform operations in accordance with the teachings described herein. Elements of the illustrated embodiment shown in software may be implemented in hardware and vice versa.

Technologies from the preceding examples can be combined in various permutations as desired. Although some examples describe an application service provider scenario, the technologies can be directed to other arrangements. Similarly, although some examples describe anti-virus software, the technologies can be directed to other arrangements.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

We claim:

1. A computer-implemented method for invoking an executable with customization data, the method comprising:
providing a software component over a network;
providing the executable over the network; and
providing the customization data over the network;
wherein the software component is operable to invoke the executable with the customization data.

2. The method of claim 1 wherein:
the software component is provided to a browser; and
the software component is operable to execute the executable outside the browser.

3. The method of claim 1 wherein the executable comprises a remote deployment utility.

4. The method of claim 3 wherein the remote deployment utility is operable to install an agent at a remote computer.

5. The method of claim 4 wherein the agent is operable to perform administration tasks for anti-virus software at the remote computer.

6. The method of claim 1 wherein:
the software component comprises an ActiveX control.

7. The method of claim 1 wherein:
the software component is embedded in a web page via an OBJECT tag.

8. The method of claim 1 wherein the providing is performed via an application service provider scenario.

9. The method of claim 1 wherein the software component is provided via an application service provider scenario.

10. The method of claim 1 wherein the software component and the executable are embedded in a web page.

11. The method of claim 10 wherein the customization data is specified by a script within the web page.

12. The method of claim 10 wherein the customization data comprises an install token.

13. The method of claim 10 wherein the web page is provided in response to activation of a user interface element in an HTML form containing information from which the customization data is derived.

14. The method of claim 10 wherein the software component is embedded in the web page via a URL pointing to a location whereat the software component can be acquired.

15. A computer-readable medium comprising computer-executable instructions for performing the following to invoke an executable with customization data:
providing a software component over a network;
providing the executable over the network; and
providing the customization data over the network;
wherein the software component is operable to invoke the executable with the customization data.

16. A system for providing execution of an executable, the system comprising:
a data center operable to deliver a document having a software component embedded therein; and
a distribution unit comprising the executable;
wherein the software component embedded in the document is operable to invoke the executable with customization data residing in the document.

17. The system of claim 16 wherein the customization data comprises an install token.

18. The system of claim 17 wherein the install token indicates installation of software comprising an agent for performing administration tasks for anti-virus software.

19. A system for providing execution of an executable, the system comprising:
means for delivering a document having a software component embedded therein; and
a distribution means comprising the executable;
wherein the software component embedded in the document is operable to invoke the executable of the distribution means with customization means residing in the document.

20. A computer-implemented method for executing an executable on a computer via a document provided over a network, the method comprising:
responsive to presentation of the document, downloading a software component embedded in the document and the executable to a computer; and
initiating execution of the executable with the software component, wherein customization data from within the document is passed to the executable.

21. The method of claim 20 further comprising:
acquiring the customization data over the network via an electronic form.

22. The method of claim 21 wherein the customization data comprises an install token specifying information to be used for remotely deploying and installing software with the executable.

23. The method of claim 20 wherein the software component comprises an ActiveX control.

24. The method of claim 20 wherein the software component comprises a Java applet.

25. The method of claim 20 wherein the executable comprises a remote deployment utility.

26. The method of claim 20 wherein the software component and the executable are packaged as a distribution unit.

27. The method of claim 26 wherein the distribution unit comprises a cabinet file.

28. The method of claim 20 wherein:
the document comprises a web page presented by a web browser; and
the executable file is executed outside the web browser.

29. The method of claim 20 wherein:
the document comprises a web page presented by a web browser; and
the executable file is executed in a process separate from the web browser.

30. The method of claim 20 wherein the document is provided an application service provider scenario.

31. The method of claim 20 wherein the method is performed in an application service provider scenario.

32. A computer-readable medium comprising computer-executable instructions for performing the following to execute an executable on a computer via a document provided over a network:
responsive to presentation of the document, downloading a software component embedded in the document and the executable to a computer; and
initiating execution of the executable with the software component, wherein customization data from the document is passed to the executable.

33. A computer-implemented method for executing a remote deployment utility at a computer, the method comprising:
receiving installation information from a computer via an HTML form;
responsive to receiving the installation information, providing a web page to the computer, wherein the web page comprises the installation information and a reference to a distribution unit; and
upon receiving a request for the distribution unit, providing the distribution unit, wherein the distribution unit comprises an ActiveX control operable to invoke the remote deployment utility with the installation information upon delivery to the computer.

34. A computer-readable medium comprising computer-executable instructions for performing the following to execute a remote deployment utility at a computer:
receiving installation information from a computer via an HTML form;
responsive to receiving the installation information, providing a web page to the computer, wherein the web page comprises the installation information and a reference to a distribution unit; and
upon receiving a request for the distribution unit, providing the distribution unit, wherein the distribution unit comprises an ActiveX control operable to invoke the remote deployment utility with the installation information upon delivery to the computer.

35. A computer-implemented method for executing a remote deployment utility at a computer to install an agent for implementing configuration directives received via an application service provider scenario, the method comprising:
receiving information indicating an installation token from a computer via an HTML form, wherein the installation token refers to the agent for implementing configuration directives received via an application service provider scenario;
responsive to receiving the installation information, providing a web page to the computer, wherein the web page comprises a script comprising the installation token and a reference to a distribution unit;
encountering the reference to the distribution unit in the web page;
upon encountering the reference to the distribution unit in the web page, downloading it to the computer, wherein the distribution unit comprises the remote deployment utility, a control operable to invoke the remote deployment utility, and a generic object;
with the script, storing the installation token in the generic object;
invoking the control to execute the remote deployment utility with the installation token in the generic object;
with the remote deployment utility, installing the agent indicated by the installation token to one or more client computers.

36. A method of performing one or more remote deployment operations on plural client computers in plural network domains, the method comprising:
acquiring a selection out of the plural client computers in the plural network domains; and
performing the remote deployment operations on the selected plural client computers in the plural network domains.

37. The method of claim 36 wherein the performing comprises:
responsive to a failure to perform a remote deployment operation on at least one of the plural client computers, providing a prompt to acquire a credential.

38. The method of claim 37 wherein the performing further comprises:
acquiring the credential;
retrying the failed remote deployment utility with the credential.

39. The method of claim 36 wherein the remote deployment operations comprise installing a copy of software at the plural client computers.

40. The method of claim 36 wherein the remote deployment operations comprise uninstalling software on the plural client computers.

41. The method of claim 36 wherein the remote deployment operations comprise updating software on the plural client computers.

42. A method of performing a remote deployment operation on plural client computers, the method comprising:
downloading a remote deployment utility and a software component from a first computer to an administrator computer via an Internet connection;
executing the remote deployment utility on the administrator computer, wherein the remote deployment utility is executed by the software component; and
performing a remote deployment on the plural client computers.

43. The method of claim 42 wherein the remote deployment operation comprises installing a copy of software on the administrator computer on the plural client computers.

44. The method of claim 42 wherein the remote deployment operation comprises uninstalling software on the plural client computers.

45. The method of claim 42 wherein the remote deployment operation comprises updating software on the plural client computers.

46. The method of claim 42 wherein the software component comprises an ActiveX control.

47. The method of claim 42 wherein the software component comprises a Java applet.

48. A method of performing a remote deployment operation on plural client computers, the method comprising:
sending instructions from a sending computer to the plural client computers, wherein at least one of the plural client computers is located on a first network domain, and wherein at least one other of the plural client computers is located on a second network domain; and
performing the remote deployment operation on the plural client computers.

49. A method of executing an executable on a computer, the method comprising:
sending customization data to a first computer from a second computer;
downloading a software component and the executable file from the first computer to the second computer;
executing the executable file on the second computer, wherein the executing is initiated by the software component, and wherein the executing is based on the customization data.

50. A computer-implemented method comprising:
displaying a list of client computers in different domains on a network;
accepting a selection from the list of client computers in more than one domain on which to perform one or more remote deployment operations;
accepting activation of a user interface element to begin the remote deployment operations; and
after activation of the user interface element, displaying a request for domain credential information for at least one of the client computers before the remote deployment operations are completed.

51. The method of claim 50 further comprising:
via an application service provider scenario, providing software for performing the displaying and accepting.

52. A computer-readable medium comprising computer-executable instructions for performing the following:
displaying a list of client computers in different domains on a network;
accepting a selection from the list of client computers in more than one domain on which to perform one or more remote deployment operations;
accepting activation of a user interface element to begin the remote deployment operations; and
after activation of the user interface element, displaying a request for domain credential information for at least one of the client computers before the remote deployment operations are completed.
